(19) United States
(12) Patent Application Publication
(10) Pub. No.: US 2014/0071831 A1
(43) Pub. Date: Mar. 13, 2014

(54) SYSTEM AND METHOD FOR CONGESTION NOTIFICATION IN AN ETHERNET OAM NETWORK

(71) Applicants: Abhishek Sinha, Woodland Hills, CA (US); Frederic Spieser, Encino, CA (US)

(72) Inventors: Abhishek Sinha, Woodland Hills, CA (US); Frederic Spieser, Encino, CA (US)

(73) Assignee: ALCATEL-LUCENT USA INC., Murray Hill, NJ (US)

(21) Appl. No.: 13/609,375

(22) Filed: Sep. 11, 2012

(51) Int. Cl. H04L 12/26

(52) U.S. Cl. 370/241.1

(57) ABSTRACT

A network element in an Ethernet OAM network is operable to detect congestion associated with an OAM domain and generate a congestion notification to MEPs in the OAM domain using a modified Ethernet OAM protocol. When a network element detects congestion in one or more queues associated with an MEP in an OAM domain, it triggers a congestion state. The MEP transmits a congestion notification to other MEPs in the OAM domain. The notifying MEP, as well as other MEPs receiving the congestion notification, initiate a network management protocol message to a network management system for the OAM domain. The MEPs in the OAM domain may also propagate the congestion notification to MEPs in higher maintenance level OAM domains.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not applicable.

### BACKGROUND OF THE INVENTION

1. Technical Field of the Invention

This invention relates generally to Ethernet networks and in particular to systems and methods for providing congestion notification in an Ethernet network using Ethernet Operations, Administration and Maintenance (OAM) protocols.

2. Description of Related Art

Enterprise or local area network (LAN) networks using Ethernet protocols are able to support multiple demanding services including, for example, voice-over-IP (VoIP), data, audio, video and multimedia applications. Various standards are being developed to enhance Ethernet to provide carrier grade, highly available metro area networks (MAN) and wide area networks (WAN). In particular, two standards, IEEE 802.1ag Standard for Local and Metropolitan Area Networks Virtual Bridged Local Area Networks Amendment 5: Connectivity Fault Management, approved in 2007, IEEE 802.3 Carrier Sense Multiple Access with Collision Detection (CSMA/CD), Section 5 dated 2008 and ITU-T Y.1731 OAM Functions And Mechanisms For Ethernet Based Networks, dated July 2011, both of which are incorporated by reference herein, define protocols for Operations, Administration and Maintenance (OAM) for an Ethernet network. Ethernet OAM helps to provide end-to-end service assurance across an Ethernet network. For example, Ethernet OAM addresses performance management in Ethernet networks and defines protocols for connectivity fault management, such as fault detection, verification, isolation and performance monitoring, such as frame loss, frame delay and delay variation.

Although the Ethernet OAM protocol as currently standardized provides a framework for addressing certain connectivity fault management and performance monitoring issues, a number of other performance monitoring issues remain to be addressed.

### BRIEF DESCRIPTION OF THE SEVERAL VIEWS OF THE DRAWINGS

FIG. 1 illustrates a schematic block diagram of an embodiment of hierarchical OAM domains in an Ethernet OAM network;

FIG. 2 illustrates a schematic block diagram of an embodiment of congestion notification within an OAM domain in an Ethernet OAM network;

FIG. 3 illustrates a schematic block diagram of an embodiment of congestion notification between OAM domains in an Ethernet OAM network;

FIG. 4 illustrates a schematic block diagram of an embodiment of propagation of congestion notification in an Ethernet OAM network;

FIG. 5 illustrates a logic flow diagram of an embodiment of congestion notification in an Ethernet OAM network;

FIG. 6 illustrates a logic flow diagram of another embodiment of congestion notification in an Ethernet OAM network;

FIG. 7 illustrates a logic flow diagram of another embodiment of congestion notification in an Ethernet OAM network;

FIG. 8 illustrates a schematic block diagram of an embodiment of a network element operable for congestion notification in an Ethernet OAM network;

FIG. 9 illustrates a schematic block diagram of an embodiment of a network interface module in a network element operable for congestion notification in an Ethernet OAM network;

FIG. 10 illustrates a logical flow diagram of an embodiment of a method for congestion identification in an Ethernet OAM network;

FIG. 11 illustrates a logical flow diagram of an embodiment of a method for monitoring congestion in an Ethernet OAM network;

FIG. 12 illustrates a schematic block diagram of an embodiment of a congestion notification message in an Ethernet OAM network; and

FIG. 13 illustrates a schematic block diagram of an embodiment of a network management protocol message in an Ethernet OAM network.

### DETAILED DESCRIPTION OF THE INVENTION

Since an end-to-end network may include different components (e.g., access networks, metro networks and core networks) that are operated by different network operators and service providers, Ethernet OAM defines hierarchically layered operations, administrative and maintenance (OAM) domains. Defined OAM domains include one or more customer domains at the highest level of hierarchy, one or more provider domains occupying an intermediate level of hierarchy, and one or more operator domains disposed at a lowest level of hierarchy. An OAM domain is assigned to a maintenance level (MA Level), e.g., one of 8 possible levels, to define the hierarchical relationship between the OAM domains in the network. In general MA levels 5 through 7 are reserved for customer domains, MA levels 3 and 4 are reserved for service provider domains, and MA levels 0 through 2 are reserved for operator domains.

A Maintenance Association is a set of Maintenance End Points (MEPs) configured with the same Maintenance Association Identifier (MAID) and maintenance level (MA Level). MEPs within a maintenance association are configured with a unique MEP identifier (MEPID) and are also configured with a list of other MEPIDs for MEPs in the same maintenance association. A flow point internal to a maintenance association is called a Maintenance Intermediate Point (MIP). MEPs are operable to initiate and monitor OAM activity in their maintenance domain while MIP nodes passively receive and respond to OAM frames initiated by MEP nodes. For example, MEP nodes are operable to initiate various OAM frames, e.g., Continuity Check (CC), TraceRoute, and Ping, to other MEP nodes in an OAM domain and to MEPs in higher hierarchical OAM domains. An MIP node can interact only with the MEP nodes of its domain. Accordingly, in terms of visibility and awareness, operator-level domains have higher OAM visibility than service provider-level domains, which in turn have higher visibility than customer-level domains. Thus, whereas an operator OAM domain has knowledge of both service provider and customer domains, the converse is not true. Likewise, a service provider domain has knowledge of customer domains but not vice versa.

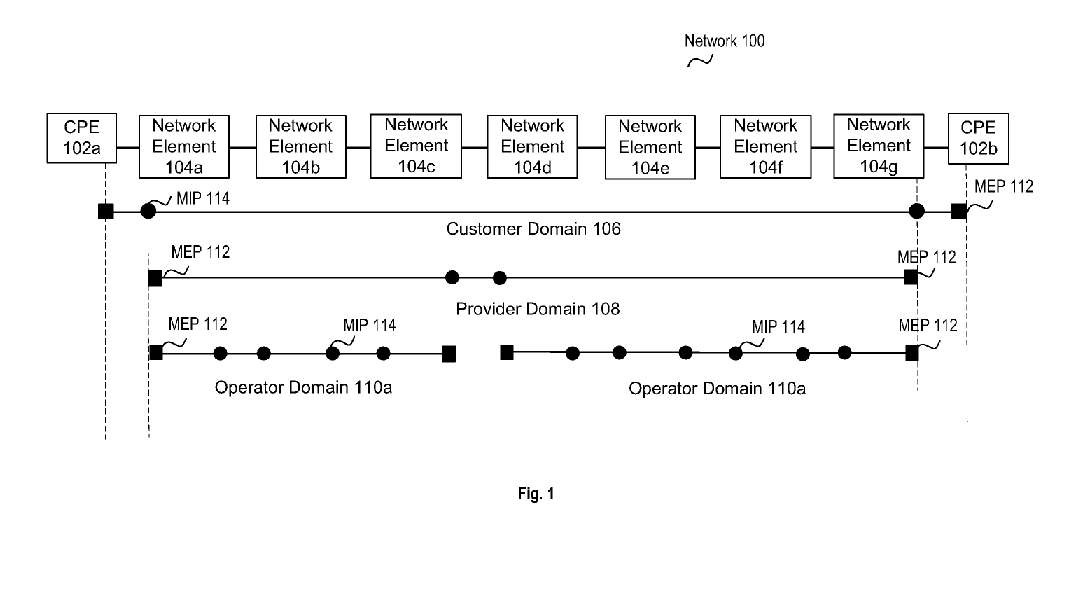

FIG. 1 illustrates a schematic block diagram of an embodiment of an Ethernet OAM network 100 with hierarchical OAM domains. The Ethernet OAM network 100 includes customer premises equipment 102a and 102b and various network elements 104a-g, such as switches, bridges and routers. The Ethernet OAM network has been logically separated into a hierarchy of OAM domains, a customer domain 106, a provider domain 108 and operator domains 110a and 110b. The customer domain 106, provider domain 108 and operator domains 110a, 110b may comprise various diverse network and transport technologies and protocols. For example, the network technologies may include Ethernet over SONET/SDH, Ethernet over ATM, Ethernet over Resilient Packet Ring (RPR), Ethernet over Multiprotocol Label Switching (MPLS), Ethernet over Internet Protocol (IP), etcetera.

The OAM domains are bounded by MEPs 112 (illustrated as squares) and include one or more internal MIPs 114 (illustrated as circles). MEPs 112 and MIPs 114 are configured in ports or NIMs of the network elements 104. A network element 104 is operable to be configured to include an MEP 112 for one or more OAM domains as well as to include an MIP 114 for one or more OAM domains. For example, in FIG. 1, Network Element 104a is configured to include an MIP 114 for customer domain 106, an MEP 112 for provider domain 108 and an MEP 112 for operator domain 110a. Accordingly, the Ethernet OAM network 100 is logically separated into a number of hierarchical levels where, at any one level, an OAM domain may be configured as one or more MIPs 114 bounded by multiple MEPs 112. Though FIG. 1 illustrates a point to point configuration of the OAM domains, point-to-multipoint configurations, ring networks, mesh networks, etc. may be configured into hierarchical OAM domains as well, e.g. with more than two MEPs 112 configured to bound an OAM domain.

Currently the Ethernet OAM protocol as defined in IEEE 802.1ag supports various management issues, such as fault detection, fault verification, fault isolation and discovery using various OAM frames, such as continuity check messages (CCM), Trace route messages and loop back messages. Continuity check messages (CCM) are used to detect connectivity failures within an OAM domain. An MEP 112 in an OAM domain transmits a periodic multicast Continuity Check Message inward towards the other MEPs 112 in the OAM domain and monitors for CCM messages from other MEPs 122. Link Trace messages are used to determine a path to a destination MEP 112. An originating MEP 112 transmits a Link Trace message to a destination MEP 112 and each MEP 112 receiving the Link Trace message transmits a Trace route Reply back to the originating MEP 112. IEEE 802.1ag also describes loop back or ping messages. An MEP 112 sending successive loopback messages can determine the location of a fault or can test bandwidth, reliability, or jitter of a service.

The ITU-T Y.1731 specification describes various OAM frames for performing OAM operations, such as Ethernet alarm indication signal (ETH-AIS), Ethernet remote defect indication (ETH-RDI), Ethernet locked signal (ETH-LCK), Ethernet test signal (ETH-Test), Ethernet automatic protection switching (ETH-APS), Ethernet maintenance communication channel (ETH-MCC), Ethernet experimental OAM (ETH-EXP), Ethernet vendor-specific OAM (ETH-VSP), Frame loss measurement (ETH-LM) and Frame delay measurement (ETH-DM).

However, the current standards fail to describe or provide a mechanism for detection and notification of congestion within a network element 104. Currently, no mechanism exists at a global, network level to determine whether congestion is occurring and at what OAM level. Though local element managers may detect congestion on a local network element, no mechanism is currently described to notify other network elements or network managers of congestion detection or a source of the congestion.

To address this issue and other problems and issues, in an embodiment, a network element 104 in an Ethernet OAM network 100 is operable to detect congestion associated with an OAM domain and generate a congestion notification to MEPs 112 in the OAM domain using a modified Ethernet OAM protocol. In an embodiment, the congestion notification includes a continuity check message (CCM) defined in IEEE 802.1ag that is enhanced to incorporate congestion information though other types of OAM frames or a newly defined OAM frame may also be implemented to perform the functions described herein. When a network element 104 in the Ethernet OAM network 100 detects congestion in one or more queues that include packets for an OAM service monitored by an MEP or otherwise associated with an MEP 112, it triggers a congestion state for the MEP 112. The MEP 112 transmits a congestion notification to other MEPs 112 in the OAM domain. The notifying MEP 112, as well as other MEPs 112 receiving the congestion notification, initiate a network management protocol message to a network management system for the OAM domain. The MEPs 112 in the OAM domain may also propagate the congestion notification to MEPs 112 in a higher maintenance level OAM domain. As such, when congestion is detected at an MEP 112 in a local network element 104, notification is provided to other network elements and network managers of the congestion detection and source of the congestion.

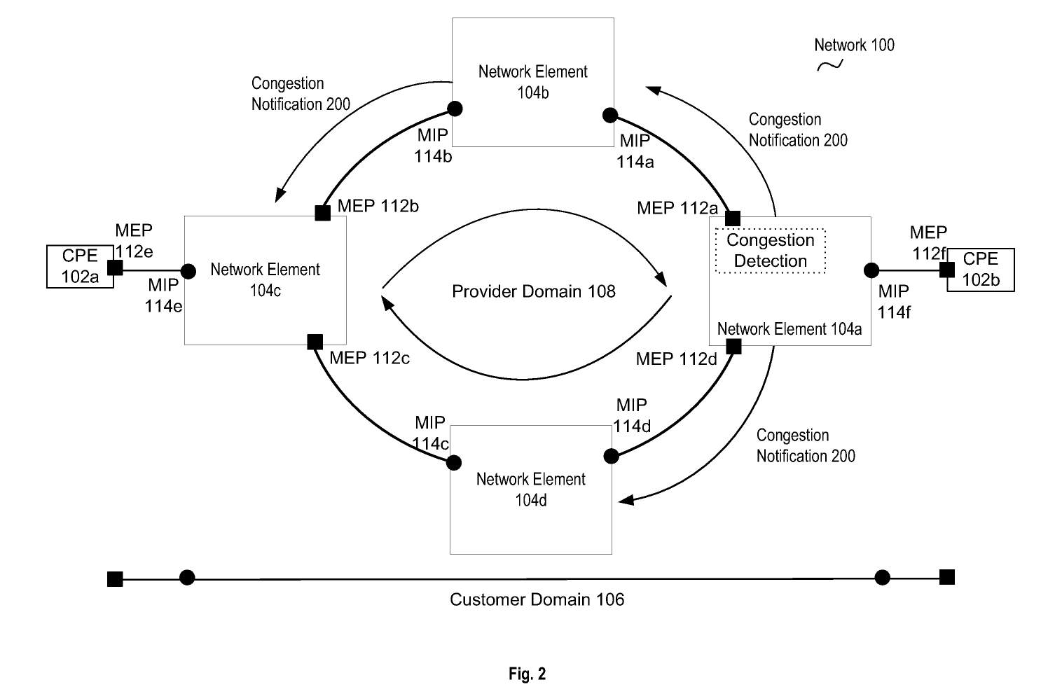

FIG. 2 illustrates a schematic block diagram of an embodiment of congestion notification within an OAM domain in an Ethernet OAM network 100. The Ethernet OAM network 100 is logically configured to include a provider domain 108 bounded by MEPs 112a, 112b, 112c and 112d with internal MIPs 114a, 114b, 114c and 114d and configured with a first maintenance level (e.g., MA level 3) and a first maintenance association identifier (MAID). The Ethernet OAM network 100 is also logically configured to include a customer domain 106 bounded by MEPs 112e and 112f with internal MIPs 114e and 114f configured with a second higher hierarchical maintenance level (e.g., MA level 7) and a second maintenance association identifier (MAID).

In an exemplary embodiment, Network Element 104a detects congestion in one or more queues associated with MEP 112a in provider domain 108. In an embodiment, the one or more queues associated with the MEP 112a are configured for a customer service instance or Ethernet virtual connection (EVC) in the provider domain 108 and monitored by MEP 112. When congestion is detected in the one or more queues, a congestion state is triggered for MEP 112a. For example, the Network element 104a detects congestion in ingress or egress queues configured to store packets labeled with a customer service instance in the provider domain 108 and monitored by MEP 112a. The Network Element 104a generates a Congestion Notification 200 that includes congestion information indicating the presence of congestion at MEP 112a in provider domain 108. The Network Element 104a transmits the Congestion Notification 200 from MEP 112a and 112d to other MEPs 112b, 112c in provider domain 108. As per OAM protocol, when internal MIPs 114a and 114b in provider domain 108 receive congestion notification 200, the internal MIPs 114a and 114b passively transmit congestion notification 200 to MEP 112b. Similarly, MIPs 114c and 114d passively transmit congestion notification 200 from MEP 112d to MEP 112c. The other MEPs 112b, c, d in provider domain 108 are thus notified of the congestion detected at MEP 112a.

In an embodiment, the Network Element 104a continues to transmit the Congestion Notification 200 at predetermined intervals while MEP 112a remains in a congestion state. When the congestion states ends, e.g. the Network Element 104a fails to detect congestion in ingress or egress queues associated with MEP 112a (e.g., queues configured with services which are monitored by MEP 112a) for a predetermined time period or for a number of consecutive time intervals, the Network Element 104a stops transmitting the Congestion Notification 200. For example, in an embodiment, when MEP 112a exits the congestion state, it transmits a CCM message, or other type of OAM message, which no longer includes a flag for congestion or other congestion information.

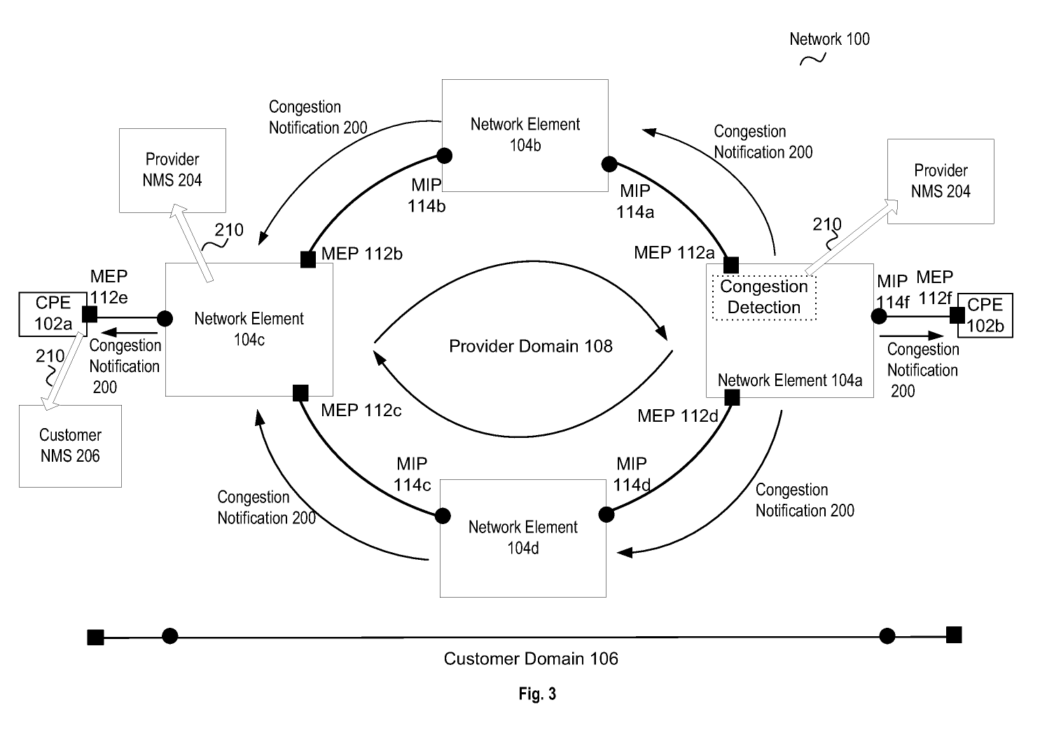

FIG. 3 illustrates a schematic block diagram of an embodiment of congestion notification between OAM domains in an Ethernet OAM network 100. As in the example in FIG. 2, the Ethernet OAM network 100 is logically configured to include a provider domain 108 bounded by MEPs 112a, 112b, 112c and 112d with internal MIPs 114a, 114b, 114c and 114d and configured with a first maintenance level (e.g., MA level 3) and a first maintenance association identifier (MAID). The Ethernet OAM network 100 is also logically configured to include a customer domain 106 bounded by MEPs 112e and 112f with internal MIPs 114e and 114f configured with a second higher hierarchical maintenance level (e.g., MA level 7) and a second maintenance association identifier (MAID).

In response to detecting congestion in one or more queues associated with MEP 112a configured in provider domain 108, MEP 112a enters a congestion state and transmits a Congestion Notification 200 to other MEPs 112b,c,d in the provider domain 108. In an embodiment, the congestion notification 200 is also propagated to a higher hierarchical level OAM domain such as customer domain 106. For example, one or more of MEPs 112b, 112c in the provider domain 108 propagate the congestion notification 200 to MEP 112e in customer domain 106. In addition, one or more of the MEPs 112a and 112d in the provider domain 108 propagate the congestion notification 200 to MEP 112f in customer domain 106. In addition, the MEPs 112e and 112f in customer domain 106 propagate the congestion notification to other MEPs 112 (not shown) in customer domain 106. As such, MEPs 112 in the higher hierarchical level OAM domain are informed of the congestion detected at MEP 112a in the lower level hierarchical OAM domain.

In addition, when an MEP 112 in an OAM domain enters a congestion state or receives a congestion notification, it is operable to notify a network management system (NMS) for the OAM domain. For example, MEP 112a in provider domain 108 transmits a network management protocol message 210 to provider NMS 204 indicating the presence of congestion at MEP 112a. In an embodiment, the network management protocol message 210 is a Simple Network Management Protocol (SNMP) trap or SNMP response though other management protocols such as INMP, TELNET, SSH, or Syslog or other types of SNMP messages may be implemented to perform the congestion notification.

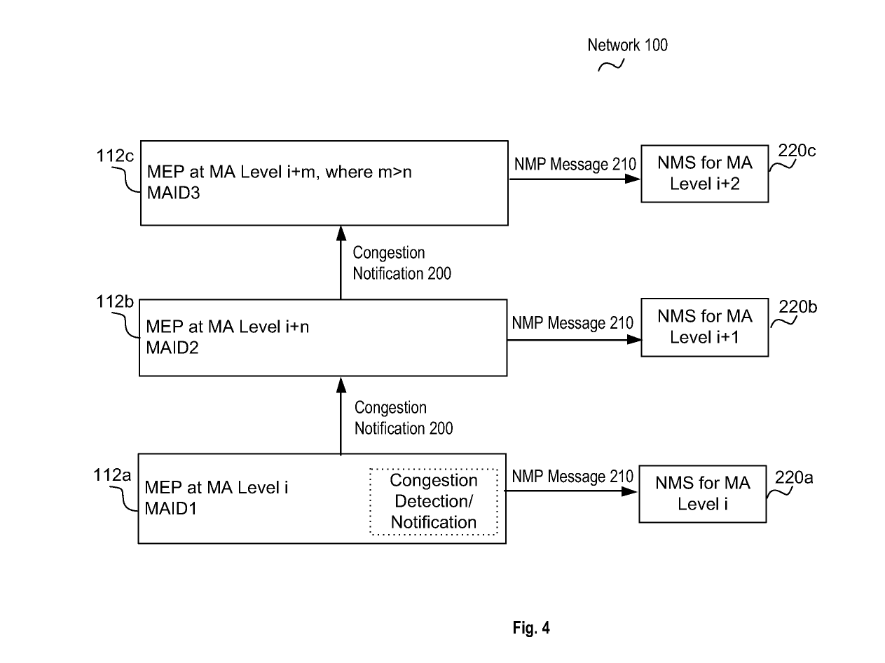

FIG. 4 is a schematic block diagram that illustrates an embodiment of propagation of congestion notification 200 in an Ethernet OAM network 100. In an example shown in FIG. 4, a three-level hierarchy of OAM domains includes an MEP 112a in an OAM domain with an assigned maintenance association (MA) level (i) and a first maintenance association ID (MAID1), an MEP 112b in an OAM domain at MA level (i+n) and a second maintenance association ID (MAID2) and an MEP 112c in an OAM domain at MA level (i+m) where m>n and a third maintenance association ID (MAID3). Associated with the OAM domains are corresponding NMS entities 220a, 220b and 220c respectively.

In normal operation, each OAM domain is monitored by level-specific CCM frames transmitted by the MEPs 112 therein. When congestion is detected at MEP 112a at MA Level i, or MEP 112a receives a congestion notification from another MEP in OAM domain at MA Level i, MEP 112a is operable to transmit a network management protocol (NMP) message 210 to the NMS 220a for its OAM domain. MEP 112a is also operable to propagate a congestion notification (such as CCM message with congestion information) to other MEPs at OAM domain at MA level i. MEP 112a is also operable to propagate a congestion notification 200 to MEP 112b at a higher hierarchical OAM domain level, e.g. OAM domain at MA Level i+n.

When MEP 112b receives a congestion notification 200 from a lower hierarchical OAM domain level, such as OAM domain MA level i, it transmit a network management protocol (NMP) message 210 to the NMS 220b for its OAM domain at MA level i+n. MEP 112b is also operable to propagate a congestion notification 200 (such as CCM message with congestion information) to other MEP nodes at OAM domain at MA level i+n. The congestion notification includes information that the congestion is detected at the lower hierarchical OAM domain with MA level i. MEP 112b is also operable to propagate a congestion notification 200 to MEP 112c at a higher hierarchical OAM domain level, e.g. OAM domain at MA Level i+m, where m>n.

Similarly, when MEP 112c receives a congestion notification 200 from a lower hierarchical OAM domain level, such as OAM domain MA level i+n, it transmit a network management protocol (NMP) message 210 to the NMS 220c for its OAM domain at MA level i+m. MEP 112c is also operable to propagate a congestion notification 200 (such as CCM message with congestion information) to other MEP nodes at OAM domain at MA level i+m. The congestion notification includes information that the congestion is detected at the lower hierarchical OAM domain with MA level i. MEP 112c is also operable to propagate a congestion notification 200 to another MEP at a higher hierarchical OAM domain level. In this manner, the higher hierarchical OAM domains and their corresponding network management systems 220 are notified of congestion and the source of the congestion.

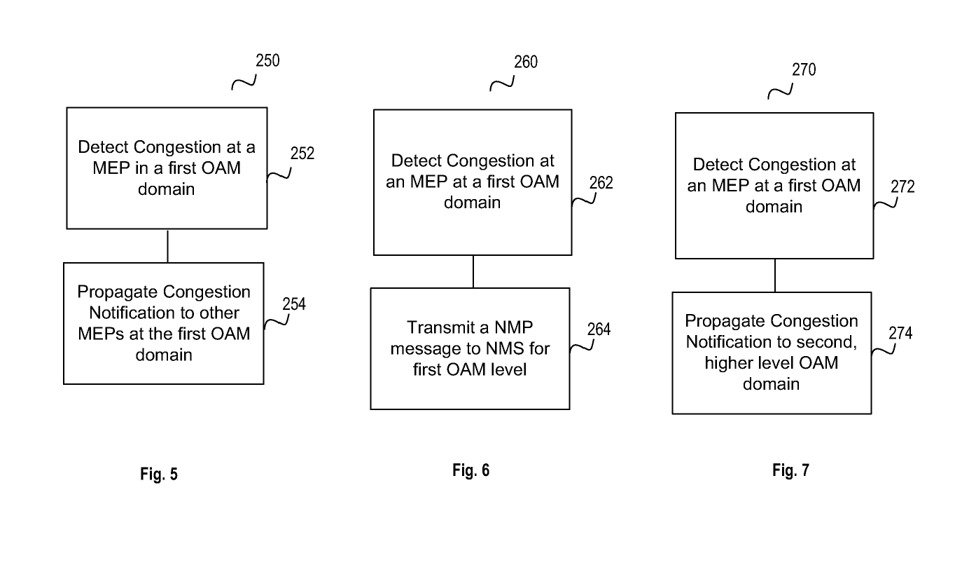

FIG. 5 illustrates a logic flow diagram 250 of an embodiment of congestion notification in an Ethernet OAM network 100. In step 252, congestion is detected at an MEP 112 in a first OAM domain at a first hierarchical OAM domain level. For example, congestion is detected in one or more ingress or egress queues associated with the MEP 112, and the MEP 112 enters into a congestion state. In step 254, a congestion notification is generated and propagated by the MEP 112 to other MEPs 112 in the first OAM domain. The congestion notification includes, for example, a CCM message with congestion information and the source of the congestion, such as an identifier for the MEP 112 (MEPID) in the congestion state.

FIG. 6 illustrates a logic flow diagram 260 of another embodiment of congestion notification in an Ethernet OAM network 100. In step 262, congestion is detected at an MEP 112 in a first OAM domain at a first hierarchical OAM domain level (or the MEP 112 receives a congestion notification from another MEP 112 at the first hierarchical OAM domain level). In response at step 264, a network management protocol (NMP) message 210 is generated by the Network Element 104 and transmitted to the NMS 220 for the OAM domain to inform the NMS 220 of the congestion.

FIG. 7 illustrates a logic flow diagram 270 of another embodiment of congestion notification in an Ethernet OAM network 100. In step 272, congestion is detected at an MEP 112 in a first OAM domain at a first hierarchical level OAM domain (or the MEP 112 receives a congestion notification from another MEP at the first hierarchical level OAM domain). In response at step 264, a congestion notification is generated and propagated by the MEP 112 in the first hierarchical level OAM domain to an MEP 112 at a second higher hierarchical level OAM domain. The congestion notification includes, for example, a CCM message with congestion information and the source of the congestion, such as an identifier for the OAM domain (such as MA level or MAID) including the MEP 112 in the congestion state. The identifier for the MEP 112 (MEPID) in the congestion state may also be included.

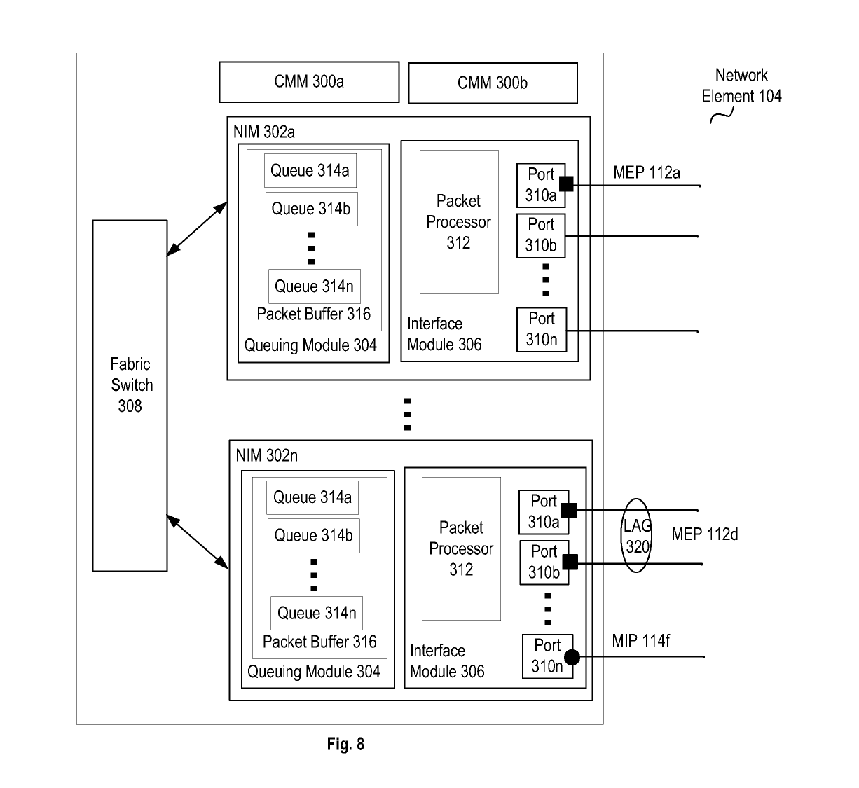

FIG. 8 illustrates a schematic block diagram of an embodiment of a network element 104 operable for congestion notification in an Ethernet OAM network 100. The network element 104 includes at least one control management module (CMM) 300a (primary) and preferably a second CMM module 300b (back-up), one or more Network Interface Modules (NIMs) 302a-n, and Fabric Switch 308. The Fabric Switch 308 is operable to provide an interconnection between the NIMs 302a-n, e.g. for switching packets between the NIMs 302a-n. NIMs 302a-n, such as line cards or port modules, include a Queuing Module 304 and Interface Module 306. Interface Module 306 includes a plurality of external interface ports 310. In an embodiment, the ports 310 may have the same physical interface type, such as copper (CAT-5E/CAT-6), multi-mode fiber (SX) or single-mode fiber (LX). In another embodiment, the ports 310 may have one or more different physical interface types. The ports 310 are assigned an external port interface identifiers (Port IDs), e.g., such as gport and dport values, associated with the Interface Modules 306. The Interface Module 306 further includes a packet processor 312 that is operable to process incoming and outgoing packets.

The Queuing Module 304 includes a packet buffer 316 with a plurality of packet queues 314a-n. One or more of the queues 314a-n are associated with a port 310. The one or more queues 314 assigned to a port 310 may include ingress packets received at the port 310 to be transmitted to other NIMs 302 or the CMM 300 or include egress packets that are to be transmitted from the port 310.

For an egress packet, the queue management 320 stores the egress packet in one or more of the queues 314 associated the destination port 310 to wait for transmission by the destination port 310. The queue module 304 determines the destination port 310 for transmission of the packet in response to a destination address or egress port id in the egress packet. For example, an address or mapping table provides information for switching the packet into an appropriate egress queue for one or more of the ports 310 based on destination address in the egress packet. For an ingress packet, the packet processor 312 determines that an ingress packet is destined for one or more ports in another NIM 302, it transmits the ingress packet to the Queuing Module 304. The queue module 304 determines one or more queues 314 to store the ingress packet for transmission to the other NIMs 152 via the fabric switch 308. Though the Interface Module 306 and Queuing Module 304 are illustrated as separate modules in FIG. 8, one or more functions or components of the modules may be included on the other module or combined into one module or otherwise be implemented in one or more modules.

In an embodiment, one or more of the external ports 310 are configured as MEPs 112 or MIPs 114 for one or more OAM domains. For example, in FIG. 8, port 310a of NIM 302a is configured as an MEP 112a for a provider domain 108 (as shown in FIG. 3). The MEP 112a is assigned a unique MEP ID for the provider domain 108, which is assigned a maintenance level (such as MA level 3) and maintenance association ID (MAID). In addition, port 310n of NIM 302n is configured as an MIP 114f for customer domain 106 (as shown in FIG. 3), which is assigned a maintenance level (such as MA level 7) and maintenance association ID (MAID). The MIP 114 is an internal port within the customer domain 106.

In an embodiment, one or more of the ports 310 are configured into a link aggregation group (LAG), as described in the Link Aggregation Control Protocol (LACP) and incorporated in IEEE 802.1AX-2008 on Nov. 3, 2008, which is incorporated by reference herein. An MEP 112 or MIP 114 may be assigned to a LAG that includes a plurality of ports 310. For example, in FIG. 8, ports 310a and 310b of NIM 302n are configured into LAG 320. LAG 320 is then assigned or configured as MEP 112d (as shown in FIG. 3). MEP 112d is assigned a unique MEP ID for the provider domain 108, which is assigned a maintenance level (such as MA level 3) and maintenance association ID (MAID).

In an embodiment, the Network Element 104 monitors one or more queues 314 associated with a port 310 configured as an MEP 112 for congestion. The CMM 300, the Queuing Module 304, Interface Module 306 and/or Fabric Switch 308 are operable to perform congestion monitoring of the queues 314 associated with an MEP 112. When the Network Element 302 determines congestion exists in one or more of the queues 314 associated with an MEP 112 (e.g., queues configured with services which are monitored by MEP 112a), the Network Element 302 enters the MEP 112 (e.g., its associated one or more queues 314 and/or ports 310) into a congestion state. The Network Element 302 then generates a congestion notification 200 as described herein. One or more of the processing modules in the Network Element 104 may perform the generation of the congestion notification 200, e.g. the CMM 302, Queuing Module 304 and/or Interface Module 306. The congestion notification 200 is then propagated as described herein.

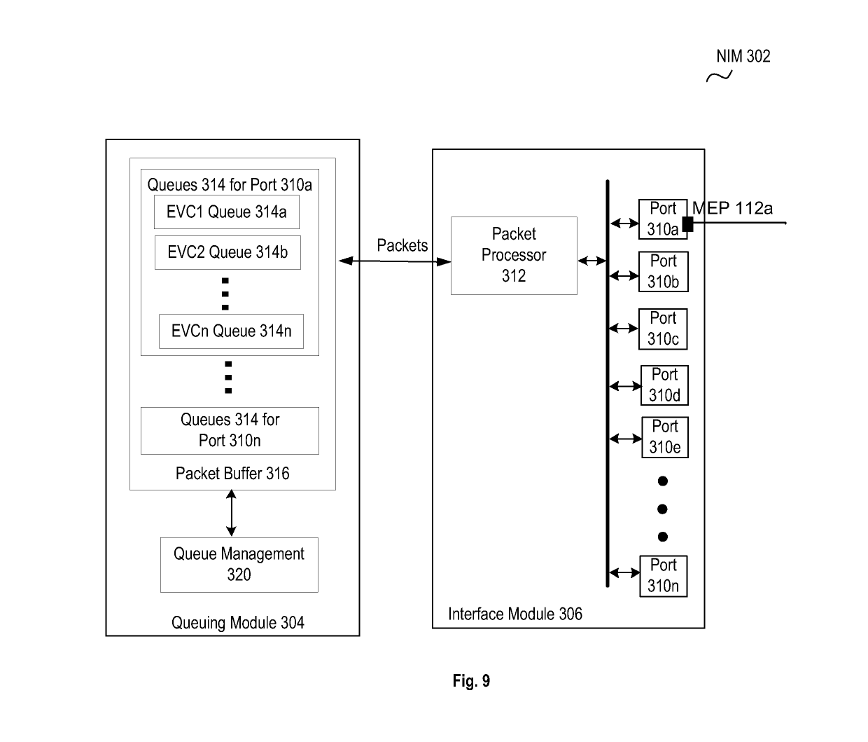

FIG. 9 illustrates a schematic block diagram of an embodiment of a network interface module 302 in a network element 104 operable for congestion notification in an Ethernet OAM network 100. Queuing module 304 includes queue management 320 that is operable to manage and monitor the queues 314 in the packet buffer 316. In an embodiment, queues 314a-n are allocated for Port 310a configured as MEP 112a. Other queues 314 are also allocated to other ports in the packet buffer 316.

In an embodiment, the queue management 320 configures one or more flow based queues to a set of VLANs associated with an MEP 112. When congestion is detected in one or more queues 314a-n configured for the set of VLANs, the VLAN ID affected by the congestion is also identified. The congestion notification includes the information on the MEP (MEPID) associated with the set of VLANs, the maintenance entity identifier (MAID) and the VLAN identifier associated with the congested queue 314.

In another embodiment, the queue management 320 dedicates one or more queues 314 per customer service instance serviced by an MEP 112 configured on a port 310. A customer service instance is an Ethernet virtual connection (EVC), which is identified by a service virtual local area network (S-VLAN) identifier. The S-VLAN identifier is a globally unique service ID. A customer service instance can thus be identified by the S-VLAN identifier. A customer service instance can be point-to-point or multipoint-to-multipoint. In an embodiment, OAM frames include the S-VLAN identifier and are issued on a per-Ethernet Virtual Connection (per-EVC) basis. In an embodiment, queue management 320 configures one or more queues 314 per EVC serviced by the OAM domain of the MEP 112. For example, in FIG. 9, queues 314a-n are allocated to store packets for EVC1-n respectively. When congestion is detected in one or more queues 314a-n, the EVC or customer service instance affected by the congestion and the MEP 112 associated with or monitoring the EVC or customer service is identified. In an embodiment, the congestion notification 200 includes the information on the MEP 112, such as (MEPID), the maintenance association identifier (MAID) and the S-VLAN identifier of the EVC associated with the congested queue.

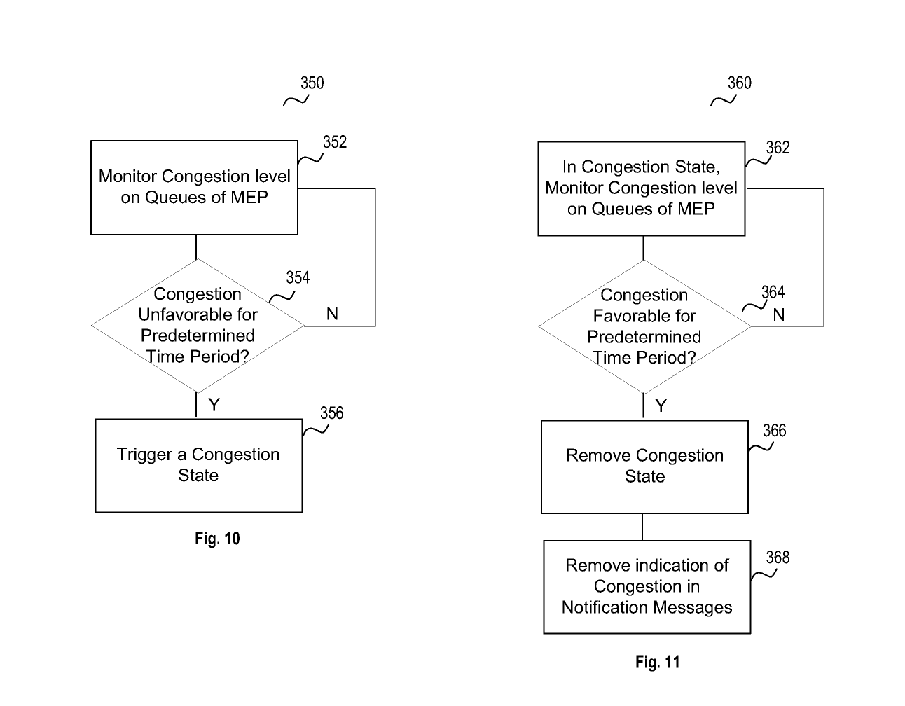

FIG. 10 illustrates a logical flow diagram of an embodiment of a method for congestion identification 350 in an OAM network 100. In step 352, one or more queues 314 associated with an MEP 112 in an OAM domain are monitored for congestion. For example, the one or more queues are configured with a customer service instance or EVC in the OAM domain monitored by the MEP 112. One or more congestion thresholds are pre-configured, e.g. thresholds related to queue depth, percentage of available queue depth, etc. In an embodiment, when a queue 314 compares unfavorably to a congestion threshold, a statistical sampling is performed on the queue 314 over a predetermined time period, e.g. at predetermined time intervals, to determine whether the queue 314 continues to compare unfavorably to the congestion threshold. This statistical sampling prevents a small burst of traffic from unnecessarily triggering a congestion state. When the congestion threshold compares unfavorably for a predetermined time period, or for a predetermined number of consecutive time intervals, as shown in step 354, a congestion state is triggered for the MEP 112 associated with the congested queue as shown in step 356.

FIG. 11 illustrates a logical flow diagram of an embodiment of a method for monitoring congestion 360 in an OAM network 100. In step 362, an MEP 112 is in a congestion state due to one or more congested queues 314. When the congestion state is triggered, the one or more congested queues 314 are continued to be monitored to determine whether the one or more queues 314 continue to compare unfavorably to the congestion threshold as shown in step 364. When the one or more congested queues 314 compare favorably to the congestion threshold for a predetermined time period or for a predetermined number of consecutive time intervals, the congestion state is exited or removed as shown in step 366. This requirement prevents removal of the congestion state prematurely. In an embodiment, when the congestion state is removed, CCM frames no longer indicate congestion at MEP 112 (e.g. a flag is removed indicating congestion) as shown in step 368. In another embodiment, when the congestion state is removed at MEP 112, a congestion notification 200 is propagated that specifically indicates removal of the congestion state. The congestion notification 200 includes a flag that indicates that the congestion state has ended or been removed at the MEP 112. As such, the other MEPs receive confirmed notice of the end of the congestion state at MEP 112.

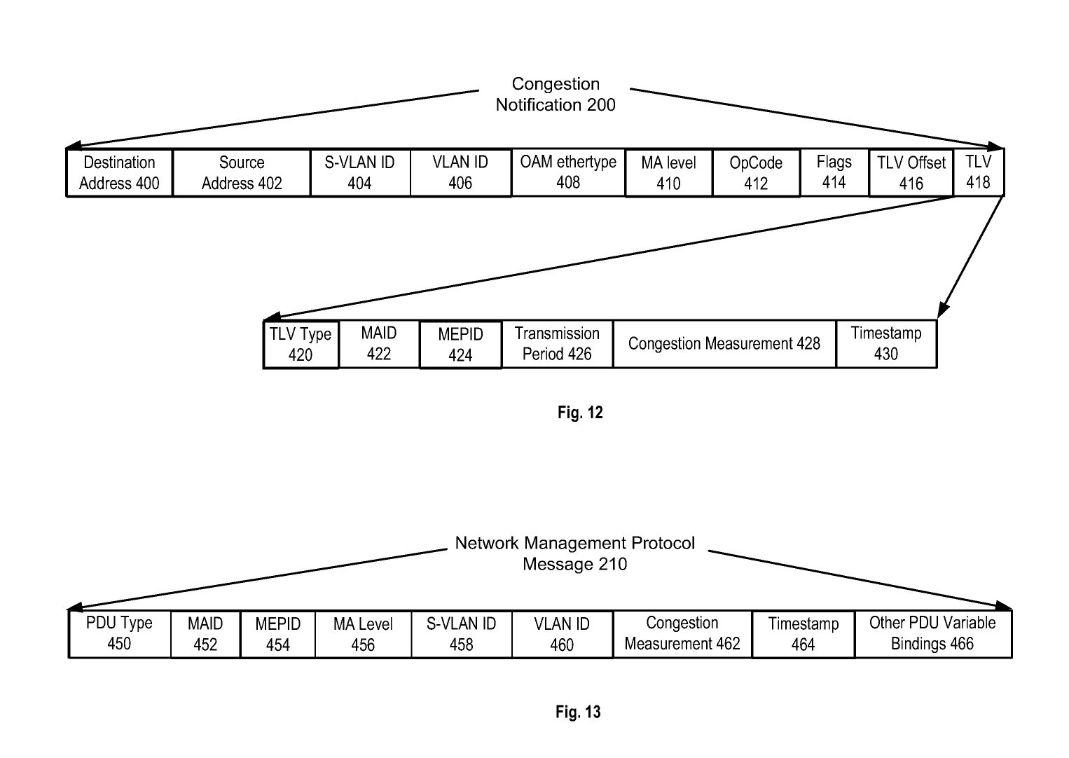

FIG. 12 illustrates a schematic block diagram of an embodiment of a congestion notification 200 in an OAM network 100. In an embodiment, the congestion notification 200 is a continuity check message (CCM) though other types of OAM frames or a new type of OAM frame may be implemented as well. The congestion notification 200 includes a destination MAC address field 400 and source MAC address field 402. The congestion notification in an embodiment includes an S-VLAN ID field 404 and/or VLAN ID (or customer VLAN tag) field 406. As described above, the S-VLAN ID 404 and/or VLAN ID 408 in the congestion notification 200 are associated with one or more congested queues of an MEP 112 in a congestion state. An OAM Ethertype 408 assigned for this type of application may be incorporated into the congestion notification 200 as well. The congestion notification 200 also includes a maintenance level (MA level) field 410 for the OAM domain of the MEP 112 in the congestion state, e.g. MA level 0-7. An OpCode field 412 designates the OAM message type, e.g. Continuity Check, Loopback, etc. In an embodiment, the congestion notification 200 includes an OpCode in a range for a Continuity Check type OAM message. The Flags field 414 includes designated bits to indicate one or more states or variables dependent on the OAM message type. In the congestion notification 200, one or more bits in the Flags field 414 is set to indicate a congestion state at the MEP 112.

The TLV Offset field 416 indicates an offset to a first TLV in the CCM relative to the TLV Offset field 416. TLVs are optional and are included in the message body. In an embodiment, the congestion notification 200 includes a TLV 418 with a new TLV type 420 defined to provide congestion information. TLV 418 includes MAID field 422 and MEPID field 424. The MAID field 422 includes the maintenance association identifier and/or a network operator that is responsible for the maintenance association of the MEP 112 in the congestion state. The MEPID field 424 includes the MEP identifier of the MEP 112 in the congestion state. The Transmission Period field 426 is encoded in the Flags field 414 and can be in the range of 3.3 ms to 10 minutes. The Congestion Measurement field 428 includes one or more parameters of congestion information, such as a percentage of a max queue size consumed at the time of notification, while the Timestamp field 430 indicates when congestion was identified on the one or more congested queues 314. The fields described in the congestion notification 200 and TLV 418 are exemplary and additional fields or alternative fields or fewer fields may also be implemented in the congestion notification 200.

FIG. 13 illustrates a schematic block diagram of an embodiment of a network management protocol (NMP) message 210 in an OAM network 100. In an embodiment, the NMP protocol message 210 is a Simple Network Management Protocol (SNMP) trap or SNMP response though other management protocols such as INMP, TELNET, SSH, or Syslog or other types of messages may be implemented to perform congestion notification to a network management system 220. The NMP message 210 includes a PDU type field 450, a MAID field 452, MEPID field 454 and MA Level field 456. The MAID field 452 includes the maintenance association identifier and/or a network operator that is responsible for the maintenance association of the MEP 112 in the congestion state. The MEPID field 454 includes the MEP identifier of the MEP 112 in the congestion state and the maintenance level (MA level) field 456 includes the maintenance level for the OAM domain of the MEP 112 in the congestion state, e.g. MA level 0-7. The NMP message 210 further includes an S-VLAN ID field 458 and/or VLAN ID (or customer VLAN tag) field 460. The S-VLAN ID 458 and/or VLAN ID 460 are associated with one or more congested queues 314 of the MEP 112 in the congestion state. The Congestion Measurement field 462 includes one or more parameters of congestion information, such as a percentage of a max queue size consumed at the time of notification, while the Timestamp field 464 indicates when congestion was identified on the one or more congested queues 314. The fields described in the NMP message 210 are exemplary and additional fields or alternative fields or fewer fields may also be implemented in the NMP message 210.

One or more embodiments described herein are operable to provide a network management system with the ability to effectively identify and monitor congestion end to end in an Ethernet OAM network across multiple geographies and multiple OAM domains. The network management system is thus able to take remedial action regarding the congestion. By receiving NMP messages of the congestion, one or more embodiments described herein provide a log of the congestion states within the Ethernet OAM network which helps in handling problems related to traffic loss.

As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item, or one item configured for use with or by another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As may also be used herein, the terms “processing module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The present invention has been described above with the aid of method steps illustrating the performance of specified functions and relationships thereof The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional schematic blocks, and other illustrative blocks, modules and components herein, can be implemented as illustrated or combined or separated into discrete components, application specific integrated circuits, processors executing appropriate software and the like or any combination thereof.

The present invention is described herein, at least in part, in terms of one or more embodiments. An embodiment is described herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements.

The term “module” is used in the description of the various embodiments of the present invention. A module includes a processing module (as described above), a functional block, hardware, and/or software stored on memory for performing one or more functions as may be described herein. Note that, if the module is implemented via hardware, the hardware may operate independently and/or in conjunction software and/or firmware. As used herein, a module may contain one or more sub-modules, each of which may be one or more modules.

While particular combinations of various functions and features of the present invention are expressly described herein, other combinations of these features and functions are likewise possible. The embodiment described herein are not limited by the particular examples described and may include other combinations and embodiments.

What is claimed is:

1. A network element operable in an Ethernet OAM network, comprising:
at least one port of the network element operable for configuration as a maintenance end point (MEP) in a first OAM domain;
at least one queue operable for association with the MEP;
at least one processing module operable to:
determine congestion in the at least one queue associated with the MEP; and
generate a first congestion notification for transmission to other MEPs in the first OAM domain, wherein the first congestion notification includes congestion information and an identifier for the MEP.

2. The network element of claim 1, wherein the at least one processing module is further operable to:
generate a network management system (NMS) message for transmission to a NMS for the first OAM domain, wherein the NMS message includes congestion information and the identifier for the MEP.

3. The network element of claim 2, wherein the at least one queue operable for association with the MEP is assigned to a service virtual local area network (S-VLAN) serviced by the first OAM domain; and
wherein the NMS message includes congestion information, the identifier for the MEP and an identifier of the S-VLAN assigned to the at least one queue with congestion.

4. The network element of claim 3, wherein the at least one processing module is further operable to generate a second congestion notification for propagation to another MEP in a second OAM domain at a higher hierarchical level, wherein the second congestion notification includes congestion information and an identifier for the first OAM domain.

5. The network element of claim 4, wherein the at least one processing module is further operable to:
monitor the at least one queue associated with the MEP in the first OAM domain;
when a congestion level in the at least one queue compares unfavorably to a congestion threshold for a first predetermined period of time, determine congestion exists in the at least one queue associated with the MEP; and
trigger a congestion state for the MEP in the first OAM domain.

6. The network element of claim 5, wherein the at least one processing module is further operable to:
after triggering a congestion state for the MEP in the first OAM domain, monitor the congestion level in the at least one queue associated with the MEP; and
when the congestion level in the at least one queue compares favorably to the congestion threshold for a second predetermined period of time, remove the congestion state for the MEP in the first OAM domain.

7. The network element of claim 6, wherein the at least one processing module is further operable to:
generate a third congestion notification for transmission to other MEPs in the first OAM domain, wherein the third congestion notification indicates that the congestion state has been removed for the MEP in the first OAM domain.

8. The network element of claim 7, wherein the at least one processing module is further operable to:
generate another NMS message for transmission to the NMS for the first OAM domain, wherein the another NMS message indicates that the congestion state has been removed for the MEP in the first OAM domain.

9. A network element operable in an Ethernet OAM network, comprising:
at least one port of the network element operable for configuration as a first maintenance end point (MEP) in a provider OAM domain at an intermediate hierarchical level;
at least one processing module operable to:
process a first congestion notification received by the first MEP from a second MEP in an operator OAM domain at a lower hierarchical level, wherein the first congestion notification includes congestion information for the operator OAM domain at the lower hierarchical level; and
generate a second congestion notification for transmission to another MEP in the provider OAM domain, wherein the second congestion notification includes the congestion information for the operator OAM domain at the lower hierarchical level.

10. The network element of claim 9, wherein the least one processing module is further operable to:
generate a network management system (NMS) message for transmission to a NMS for the provider OAM domain at the intermediate hierarchical level, wherein the NMS message includes the congestion information for the operator OAM domain at the lower hierarchical level.

11. The network element of claim 10, wherein the at least one processing module is further operable to:
generate a third congestion notification for propagation to a third MEP in a customer OAM domain at a higher hierarchical level, wherein the third congestion notification includes the congestion information for the operator OAM domain at the lower hierarchical level.

12. The network element of claim 11, wherein the at least one processing module is further operable to:
process a fourth congestion notification received by the first MEP from the second MEP in the operator OAM domain at the lower hierarchical level, wherein the fourth congestion notification includes an indication that the congestion state has been removed in the operator OAM domain at the lower hierarchical level; and
generate a fifth congestion notification for transmission to the another MEP in the provider OAM domain, wherein the second congestion notification includes the indication that the congestion state has been removed in the operator OAM domain at the lower hierarchical level; and
generate a sixth congestion notification for propagation to the third MEP in a customer OAM domain at a higher hierarchical level, wherein the third congestion notification includes the indication that the congestion state has been removed in the operator OAM domain at the lower hierarchical level.

13. The network element of claim 12, wherein the least one processing module is further operable to:
generate another network management system (NMS) message for transmission to the NMS for the provider OAM domain at the intermediate hierarchical level, wherein the NMS message includes the indication that the congestion state has been removed in the operator OAM domain at the lower hierarchical level.

14. A method operable in a network element, comprising:
configuring at least one port of the network element as a maintenance end point (MEP) in a first OAM domain;
associating at least one queue in the network element with the MEP;
determining congestion in the at least one queue associated with the MEP; and
generating a first congestion notification for transmission to other MEPs in the first OAM domain, wherein the first congestion notification includes congestion information and an identifier for the MEP.

15. The method of claim 14, further comprising:
generating a network management system (NMS) message for transmission to a NMS for the first OAM domain, wherein the NMS message includes congestion information and the identifier for the MEP.

16. The method of claim 15, wherein a service virtual local area network (S-VLAN) serviced by the first OAM domain is assigned to the at least one queue operable for association with the MEP; and
wherein the NMS message includes congestion information, the identifier for the MEP and an identifier of the S-VLAN assigned to the at least one queue with congestion.

17. The method of claim 16, further comprising:
generating a second congestion notification for propagation to another MEP in a second OAM domain at a higher hierarchical level, wherein the second congestion notification includes congestion information and an identifier for the first OAM domain.

18. The method of claim 17, further comprising:
monitoring the at least one queue associated with the MEP in the first OAM domain;
when a congestion level in the at least one queue compares unfavorably to a congestion threshold for a first predetermined period of time, determining congestion exists in the at least one queue associated with the MEP; and
triggering a congestion state for the MEP in the first OAM domain.

19. The method of claim 18, further comprising:
after triggering a congestion state for the MEP in the first OAM domain, monitoring the congestion level in the at least one queue associated with the MEP; and
when the congestion level in the at least one queue compares favorably to the congestion threshold for a second predetermined period of time, removing the congestion state for the MEP in the first OAM domain.

20. The method of claim 19, further comprising:
generating a third congestion notification for transmission to other MEPs in the first OAM domain, wherein the third congestion notification indicates that the congestion state has been removed for the MEP in the first OAM domain; and
generating another NMS message for transmission to the NMS for the first OAM domain, wherein the another NMS message indicates that the congestion state has been removed for the MEP in the first OAM domain.
